(19) United States
(12) Patent Application Publication
(10) Pub. No.: US 2026/0219563 A1
(43) Pub. Date: Jul. 30, 2026

(54) SUPPORTING MODULE AND PROJECTION DEVICE

(71) Applicant: Coretronic Corporation, Hsin-Chu (TW)

(72) Inventors: Meng-Chu HUNG, Hsin-Chu (TW); Yung-Chuan TSENG, Hsin-Chu (TW)

(21) Appl. No.: 19/444,053

(22) Filed: Jan. 8, 2026

(30) Foreign Application Priority Data
Jan. 24, 2025 (CN) 202520166923.8

(51) Int. Cl. G03B 21/14

(52) U.S. Cl. CPC G03B 21/145

(57) ABSTRACT

Disclosed is a supporting module including a mask member and a foot pad assembly. The mask member includes a protection wall and a surrounding wall that jointly define a channel. The protection wall connects to one end of the surrounding wall, the other end of the surrounding wall connects to a bottom cover of a projection device, and an opening of the surrounding wall communicating with the channel corresponds to a hole of the bottom cover, so that the channel communicates with outside of the projection device. The foot pad assembly includes a rod with a free end selectively extending into the channel through the opening and the hole, and a foot pad fixed to a fixed end of the rod. When the rod is screwed to the projection device, the rod is screwed to the mask member, and the foot pad is located outside the projection device.

### CROSS REFERENCE TO RELATED PRESENT DISCLOSURE

This application claims the priority benefit of China Patent Application No. 202520166923.8, filed on January 24, 2025, the entire content of which is hereby incorporated by reference herein.

### TECHNICAL FIELD

The present disclosure relates to a supporting module and a projection device, in particular to a supporting module which may meet the diversified requirements of users for installing the projection device and a projection device using the supporting module.

### RELATED ART

The bottom of the projection device is usually provided with foot pad assemblies, and the placement angle of the projection device is adjusted by the foot pad assemblies to change the projection angle of the projection image to meet different projection requirements. The existing foot pad assembly usually includes a screw and a nut. One end of the screw is provided with a foot pad. The nut is glued and fixed in the projection device. The other end of the screw away from the foot pad passes through a screw hole of a bottom housing of the projection device and is locked by the nut in the projection device, so that the screw is blocked when it is about to be rotated away from the bottom housing of the projection device, and accordingly the foot pad assembly cannot be rotated and removed from the bottom housing of the projection device.

Thus, the existing foot pad assembly is designed with the structural design of adjusting the placement angle of the projection device to change the projection angle of the projection image, and does not further consider the diverse requirements for installing the projection device (e.g., the removal of the foot pad assembly), so that it is difficult to meet the requirements of users.

The information disclosed in this Background section is only for enhancement of understanding of the background of the described technology and therefore it may contain information that does not form the prior art that is already known to a person of ordinary skill in the art. Further, the information disclosed in the Background section does not mean that one or more problems to be resolved by one or more embodiments of the disclosure was acknowledged by a person of ordinary skill in the art.

### SUMMARY

An embodiment of the present disclosure provides a supporting module, which is applied to a projection device and includes a mask member and a foot pad assembly. The mask member is disposed in the projection device, and the mask member includes a protection wall and a surrounding wall. The surrounding wall has a first end and a second end opposite to each other. The protection wall is located at the first end of the surrounding wall and is connected to a periphery of the surrounding wall. The protection wall and the surrounding wall jointly define a channel, and the channel extends along a first direction from the first end to the second end of the surrounding wall. The second end of the surrounding wall is connected to a bottom cover of the projection device, the second end of the surrounding wall has an opening communicating with the channel, and the opening corresponds to a hole of the bottom cover, so that the channel communicates with the outside of the projection device. The mask member has a first threaded portion. The foot pad assembly is removably screwed to the projection device. The foot pad assembly includes a rod and a foot pad. The rod has a fixed end and a free end opposite to each other. The foot pad is fixed to the fixed end of the rod. The free end of the rod selectively extends into the channel through the opening and the hole. The rod has a second threaded portion. When the rod is screwed to the projection device, the second threaded portion of the rod and the first threaded portion of the mask member are screwed to each other, and the foot pad is located outside the projection device.

An embodiment of the present disclosure further provides a projection device, which includes a bottom cover, at least three mask members and at least three foot pad assemblies. The bottom cover is provided with at least three holes. The at least three mask members are disposed in the projection device and are in one-to-one correspondence with the at least three holes. The at least three foot pad assemblies are in one-to-one correspondence with the at least three mask members and are removably screwed to the at least three mask members respectively. Each mask member includes a protection wall, a surrounding wall, and a first threaded portion, wherein, in each mask member, the surrounding wall has a first end and a second end opposite to each other, the protection wall is located at the first end of the surrounding wall and is connected to a periphery of the surrounding wall, the protection wall and the surrounding wall jointly define a channel, the channel extends along a first direction from the first end to the second end of the surrounding wall, the second end of the surrounding wall is connected to the bottom cover of the projection device, the second end of the surrounding wall has an opening communicating with the channel, and the opening corresponds to one of the at least three holes of the bottom cover, so that the channel communicates with the outside of the projection device. Each foot pad assembly includes a rod and a foot pad, wherein, in each foot pad assembly, the rod has a fixed end and a free end opposite to each other, the foot pad is fixed to the fixed end of the rod, the free end of the rod selectively extends into the channel through the opening corresponding thereto and the hole corresponding thereto, the rod has a second threaded portion; when the rod is screwed to the projection device, the second threaded portion of the rod and the first threaded portion of the mask member corresponding thereto are screwed to each other, and the foot pad is located outside the projection device.

Other objectives, features and advantages of the present invention will be further understood from the further technological features disclosed by the embodiments of the present invention wherein there are shown and described preferred embodiments of this invention, simply by way of illustration of modes best suited to carry out the invention.

### BRIEF DESCRIPTION OF THE DRAWINGS

FIG. 1 is a stereoscopic diagram of an embodiment of a supporting module of the present disclosure applied to a projection device.

FIG. 2 is an exploded diagram of an embodiment of the supporting module of FIG. 1 applied to the projection device.

FIG. 3 is a combined diagram of FIG. 2.

FIG. 4 is a partial enlarged diagram of area A of FIG. 3.

FIG. 5 is a stereoscopic cross-sectional diagram of FIG. 4.

FIG. 6 is a cross-sectional diagram taken along a line BB’ in FIG. 4.

FIG. 7 is a stereoscopic schematic diagram of a foot pad assembly of the present disclosure.

FIG. 8 is a stereoscopic cross-sectional diagram of an embodiment of a supporting module of the present disclosure applied to a projection device.

FIG. 9 is a stereoscopic cross-sectional diagram of another embodiment of a supporting module of the present disclosure applied to a projection device.

FIG. 10 is a stereoscopic cross-sectional diagram of still another embodiment of a supporting module of the present disclosure applied to a projection device.

### DETAILED DESCRIPTION OF THE EMBODIMENTS

In the following detailed description of the preferred embodiments, reference is made to the accompanying drawings which form a part hereof, and in which are shown by way of illustration specific embodiments in which the invention may be practiced. In this regard, directional terminology, such as “top,” “bottom,” “front,” “back,” etc., is used with reference to the orientation of the Figure(s) being described. The components of the present invention can be positioned in a number of different orientations. As such, the directional terminology is used for purposes of illustration and is in no way limiting. On the other hand, the drawings are only schematic and the sizes of components may be exaggerated for clarity. It is to be understood that other embodiments may be utilized and structural changes may be made without departing from the scope of the present invention. Also, it is to be understood that the phraseology and terminology used herein are for the purpose of description and should not be regarded as limiting. The use of “including,” “comprising,” or “having” and variations thereof herein is meant to encompass the items listed thereafter and equivalents thereof as well as additional items. Unless limited otherwise, the terms “connected,” “coupled,” and “mounted” and variations thereof herein are used broadly and encompass direct and indirect connections, couplings, and mountings. Similarly, the terms “facing,” “faces” and variations thereof herein are used broadly and encompass direct and indirect facing, and “adjacent to” and variations thereof herein are used broadly and encompass directly and indirectly “adjacent to”. Therefore, the description of “A” component facing “B” component herein may contain the situations that “A” component directly faces “B” component or one or more additional components are between “A” component and “B” component. Also, the description of “A” component “adjacent to” “B” component herein may contain the situations that “A” component is directly “adjacent to” “B” component or one or more additional components are between “A” component and “B” component. Unless limited otherwise, the terms “connected,” “coupled,” and “mounted,” and variations thereof herein are used broadly and encompass direct and indirect connections, couplings, and mountings. Accordingly, the drawings and descriptions will be regarded as illustrative in nature and not as restrictive.

The present disclosure provides a supporting module, which may meet the diversified requirements of users for installing the projection device, so that the foot pad assembly may be selectively removed from the projection device, thereby meeting actual applications.

The present disclosure further provides a projection device, which includes the above-mentioned supporting module, and may meet the diversified requirements of users for installing the projection device, so that the foot pad assembly may be selectively removed from the projection device, thereby meeting actual applications.

Other objectives and advantages of the present disclosure may be further understood from the technical features disclosed in the present disclosure.

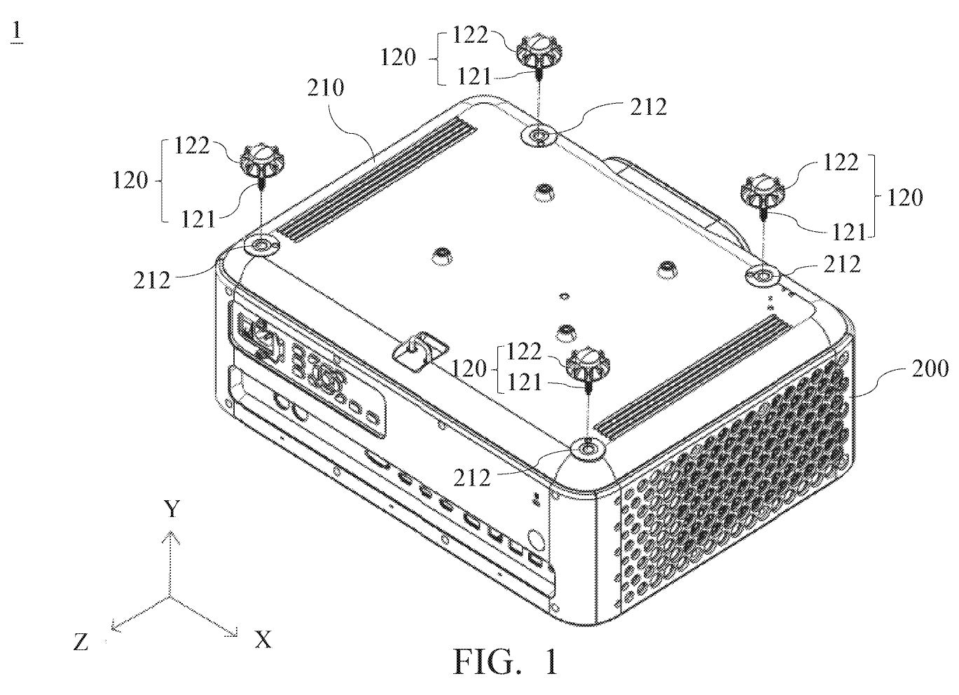

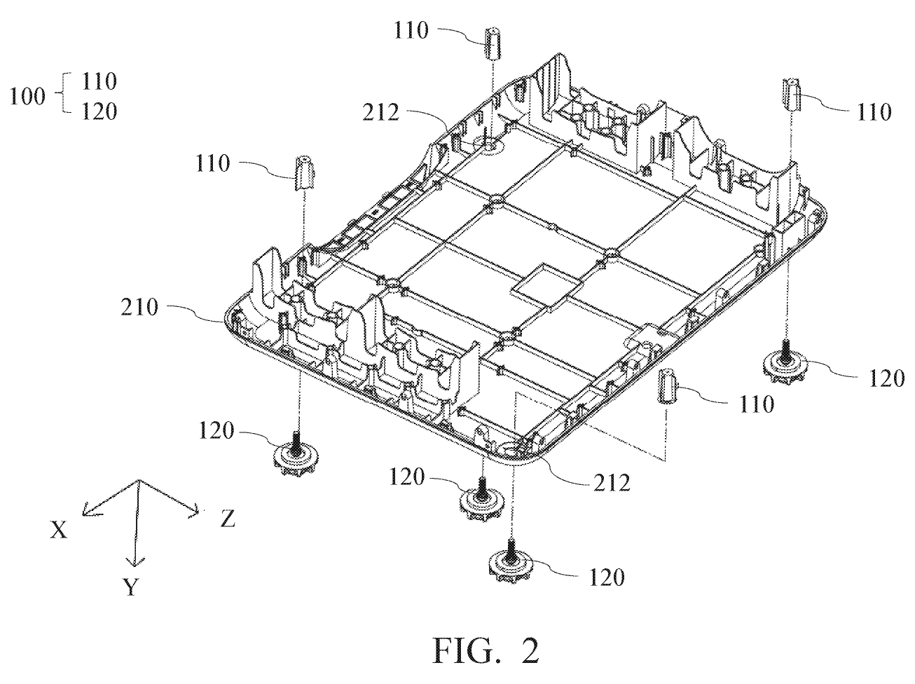

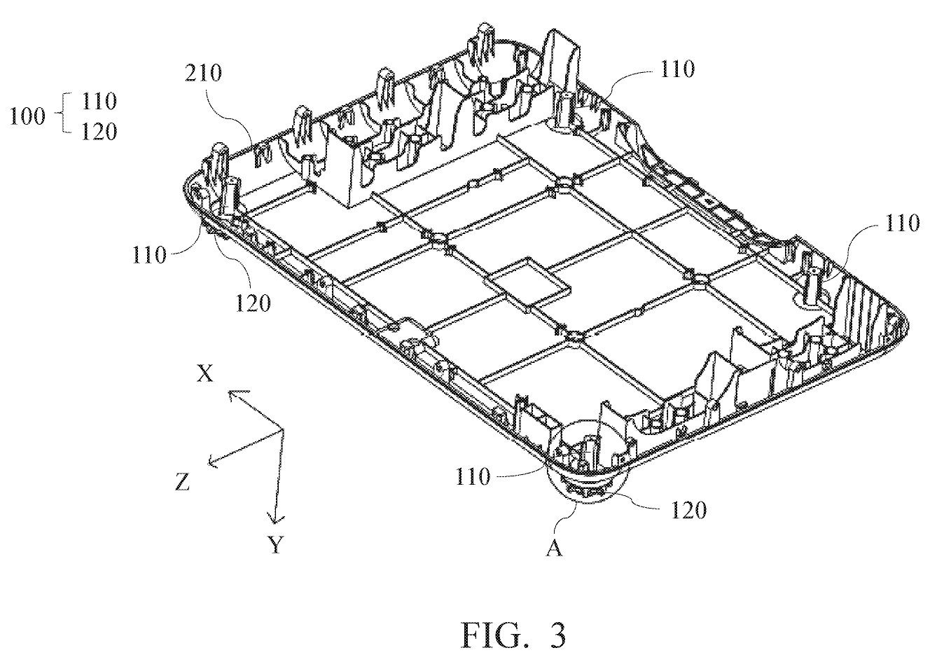

Please refer to FIG. 1 to FIG. 3, FIG. 1 is a stereoscopic diagram of an embodiment of a supporting module of the present disclosure applied to a projection device, FIG. 2 is an exploded diagram of an embodiment of the supporting module of FIG. 1 applied to the projection device, and FIG. 3 is a combined diagram of FIG. 2. As shown in FIG. 1 to FIG. 3, a projection device 1 comprises a top cover 200 and a bottom cover 210. The top cover 200 and the bottom cover 210 form a space (not shown) after assembly, and light sources, optical components, electronic components, heat dissipation components, and optical engines of the projection device 1 are, for example, disposed in the space. A supporting module 100 is applied to the projection device 1 and the supporting module 100 comprises a mask member 110 and a foot pad assembly 120. Specifically, the projection device 1 comprises at least three supporting modules 100, that is, at least three mask members 110 and at least three foot pad assemblies 120. The bottom cover 210 is provided with at least three holes 212. The at least three mask members 110 are disposed in the space of the projection device 1 and are in one-to-one correspondence with the at least three holes 212. The at least three foot pad assemblies 120 are in one-to-one correspondence with the at least three mask members 110 and are screwed to the at least three mask members 110 respectively. The at least three foot pad assemblies 120 are also removable from the at least three mask members 110. The long side of the bottom cover 210 is defined on an X-axis, the short side of the bottom cover 210 is defined on a Z-axis, the thickness of the projection device 1 is defined on a Y-axis, and the X-axis, the Y-axis and the Z-axis are orthogonal to each other, wherein a direction in which the at least three foot pad assemblies 120 are removed from the projection device 1 is defined as a positive Y-axis direction, and a negative Y-axis direction is a direction toward the inside of the projection device 1.

In this embodiment, the number of the supporting modules 100 and holes 212 of the bottom cover 210 may be four (that is, the number of the mask members 110 and the foot pad assemblies 120 may also be four), wherein the four holes 212 are, for example, respectively located at the four corners of the bottom cover 210, and the four supporting modules 100 correspond to the four holes 212 respectively. In other embodiments, the number of the supporting modules 100 and holes 212 of the bottom cover 210 may be three, wherein two of the three holes 212 are, for example, located at two corners corresponding to one long side of the bottom cover 210, one of the three holes 212 is, for example, located adjacent to the center of another long side of the bottom cover 210, and the three supporting modules 100 correspond to three holes 212, respectively, but not limited thereto. Since the plurality of supporting modules 100 in the above embodiments are very similar or even identical to each other, the structural design of one of the supporting modules 100 and the mask member 110 and the foot pad assembly 120 included therein will be described in detail below, and the structural design of the other supporting modules 100 can be deduced accordingly.

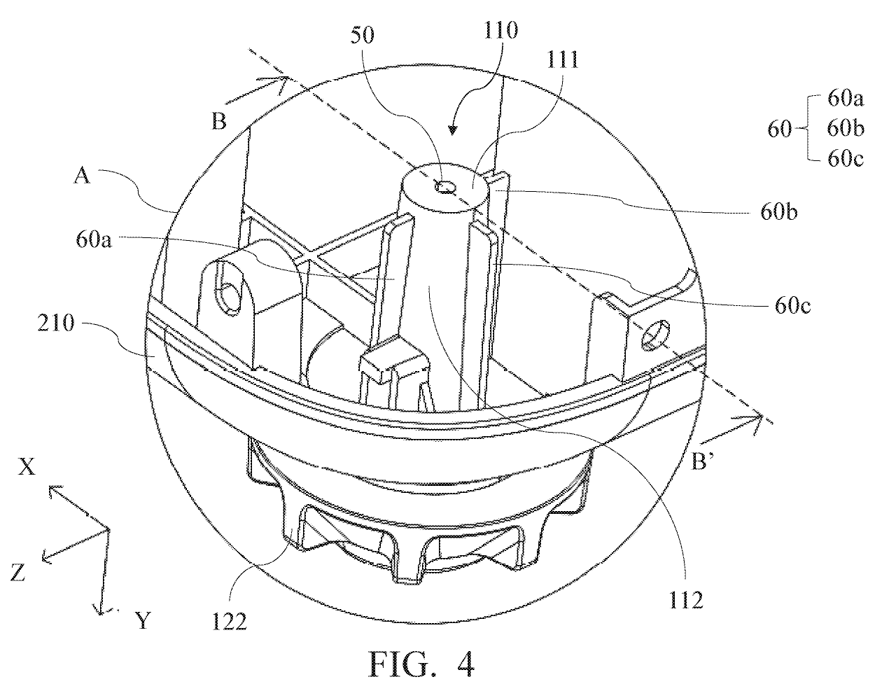

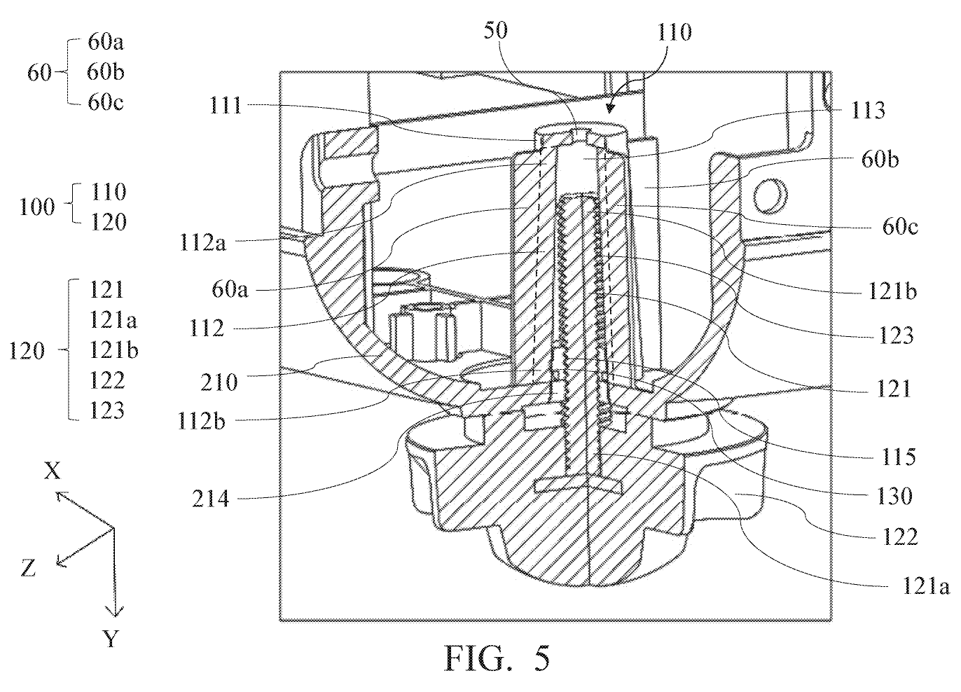

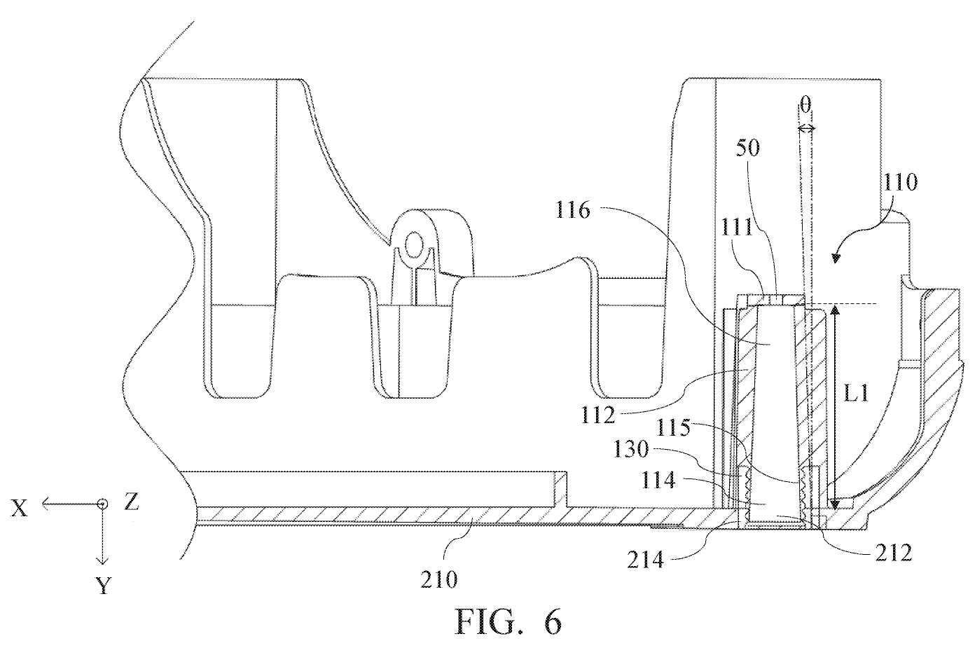

Please refer to FIG. 4 to FIG. 6, FIG. 4 is a partial enlarged diagram of area A of FIG. 3, FIG. 5 is a stereoscopic cross-sectional diagram of FIG. 4, and FIG. 6 is a cross-sectional diagram taken along a line BB’ in FIG. 4. As shown in FIG. 4 to FIG. 6, the mask member 110 comprises a protection wall 111 and a surrounding wall 112. The surrounding wall 112 has a first end 112a and a second end 112b opposite to each other. The protection wall 111 is located at the first end 112a of the surrounding wall 112 and is connected to the periphery of the surrounding wall 112. The protection wall 111 and the surrounding wall 112 jointly define a channel 113. The channel 113 extends along a first direction (i.e., the positive Y-axis direction) from the first end 112a to the second end 112b of the surrounding wall 112. The second end 112b of the surrounding wall 112 is connected to the bottom cover 210 of the projection device 1. The second end 112b of the surrounding wall 112 has an opening 114 communicating with the channel 113 (i.e., the mask member 110 forms the opening 114 toward the bottom cover 210 of the projection device 1), and the opening 114 corresponds to one of the at least three holes 212 of the bottom cover 210, so that the channel 113 communicates with the outside of the projection device 1. That is, the channel 113 may communicate with the outside of the projection device 1 through the opening 114 and the hole 212. A diameter of the opening 114 may be equal to a diameter of the hole 212, a diameter of the channel 113 may be smaller than or equal to the diameter of the hole 212, and the contours of the opening 114 and the hole 212 may be, but are not limited to, circular or quasi-circular shapes. The second end 112b of the surrounding wall 112 may be connected to the bottom cover 210 of the projection device 1 by welding, bonding, clamping or any other suitable connection method. An alignment structure 60 for positioning connection with the bottom cover 210 of the projection device 1 extends outward around the outer surface of the wall 112 along its circumferential direction. The alignment structure 60 may comprise a protrusion portion 60a, a protrusion portion 60b and a protrusion portion 60c, the protrusion portion 60a and the protrusion portion 60b are arranged at an interval of 180 degrees, the protrusion portion 60a and the protrusion portion 60c are arranged at an interval of 90 degrees, and the protrusion portion 60b and the protrusion portion 60c are arranged at an interval of 90 degrees. The mask member 110 may be positioned and connected to the bottom cover 210 of the projection device 1 through the angular configuration of the protrusion portions 60a, 60b and 60c. For example, the extension directions of the protrusion portion 60a and the protrusion portion 60b are perpendicular to the long side of the bottom cover 210, and the extension direction of the protrusion portion 60c is perpendicular to the short side of the bottom cover 210. The channel 113 may extend along the Y axis. However, if a user has special needs, the channel 113 may extend obliquely relative to the Y axis.

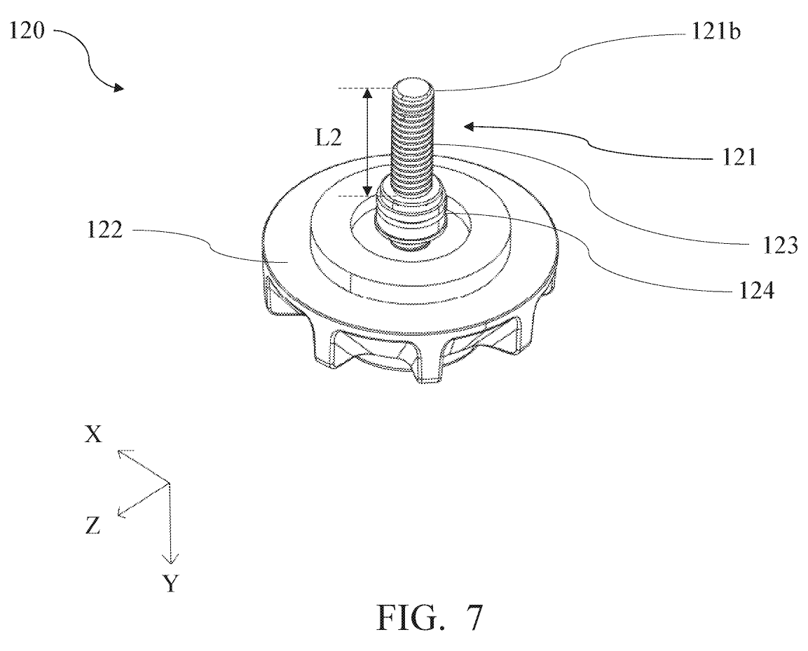

Please refer to FIG. 5 to FIG. 7, and FIG. 7 is a stereoscopic schematic diagram of a foot pad assembly of the present disclosure. As shown in FIG. 5 to FIG. 7, the foot pad assembly 120 comprises a rod 121 and a foot pad 122. The rod 121 has a fixed end 121a and a free end 121b opposite to each other. The foot pad 122 is fixed to the fixed end 121a of the rod 121. The free end 121b of the rod 121 selectively extends into the channel 113 through the hole 212 of the bottom cover 210 corresponding thereto and the opening 114 of the mask member 110 corresponding thereto. The rod 121 has a second threaded portion 123. When the foot pad assembly 120 is screwed to the projection device 1, the second threaded portion 123 of the rod 121 and the first threaded portion 115 of the mask member 110 corresponding thereto are screwed to each other, and the foot pad 122 is located outside the projection device 1.

In this embodiment, when the rod 121 of the foot pad assembly 120 is screwed to the mask member 110 disposed in the projection device 1, the foot pad 122 may be rotated to drive the rod 121 to rotate, thereby adjusting the height or tilt angle of the projection device 1. When the rod 121 is rotated to make the second threaded portion 123 disengage from the first threaded portion 115, the rod 121 may be detached from the mask member 110 and the bottom cover 210 of the projection device 1, so that the foot pad assembly 120 may be removed from the projection device 1 (that is, the foot pad assembly 120 is removably screwed to the projection device 1). In addition, in order to make the foot pad assembly 120 removable from the projection device 1, the free end 121b of the rod 121 does not have any element that prevents the rod 121 from being detached from the channel 113 (e.g., an element with a diameter wider than the diameter of the channel 113). Therefore, there is no problem that the existing foot pad assembly cannot be rotated away from the projection device due to the locking of the nut fixed in the projection device. That is, the rod 121 of the foot pad assembly 120 may be separated from the channel 113 (opening 114) of the mask member 110 and the hole 212 of the bottom cover 210.

In one embodiment, when the rod 121 is screwed to the projection device 1, the rod 121 may be configured to rotate relative to the mask member 110 to move in the channel 113 along the first direction (i.e., the positive Y-axis direction) or along an opposite direction to the first direction (i.e., the negative Y-axis direction) (as shown in FIG. 5).

In one embodiment, the outer surface of the rod 121 may comprise the second threaded portion 123 and a non-threaded portion 124. Among them, the second threaded portion 123 may be provided with an external thread, and the non-threaded portion 124 may be disposed between the second threaded portion 123 and the foot pad 122 fixed to the fixed end 121a of the rod 121 (as shown in FIG. 7), but is not limited thereto.

In one embodiment, the mask member 110 may comprise the first threaded portion 115 and an accommodation portion 116, wherein the first threaded portion 115 may be an internal thread disposed on the inner wall of the channel 113, and the accommodation portion 116 corresponds to the non-threaded portion of the channel 113, wherein the inner wall of the channel 113 corresponding to the accommodation portion 116 may be a smooth surface (as shown in FIG. 6 ). In other words, a part of the inner wall of the channel 113 is provided with an internal thread, and another part of the inner wall of the channel 113 is provided without the internal thread and is a smooth surface, so that the external thread of at least part of the second threaded portion 123 of the rod 121 may be screwed to the internal thread disposed on at least part of the inner wall of the channel 113.

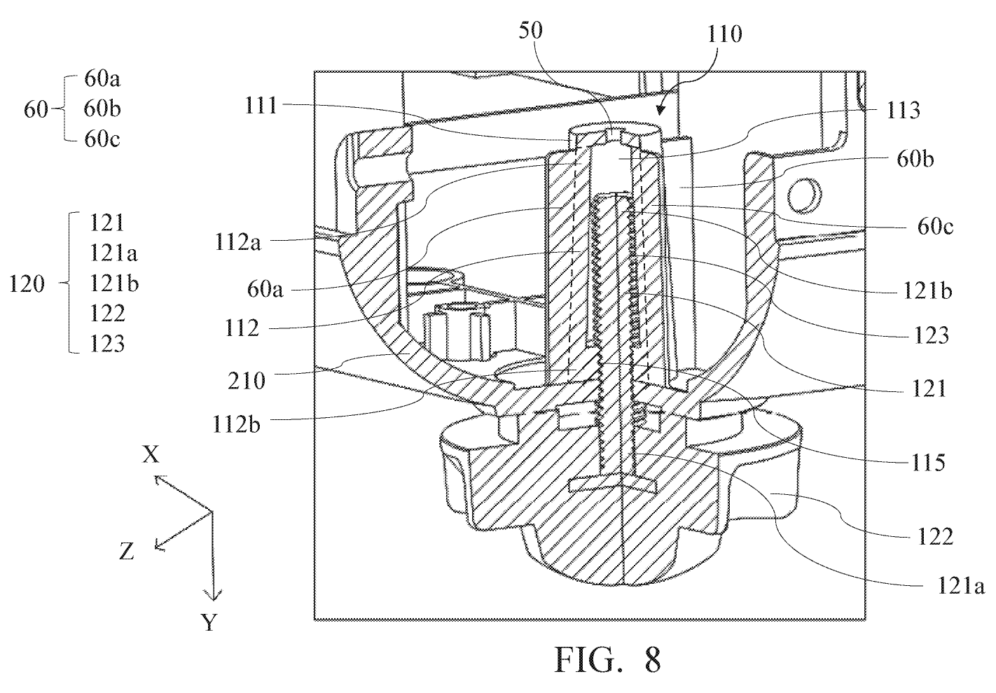

FIG. 8 is a stereoscopic cross-sectional diagram of an embodiment of a supporting module of the present disclosure applied to a projection device. In this embodiment, the internal thread disposed on the inner wall of the channel 113 corresponding to the first threaded portion 115 may be formed by directly setting a thread groove on the inner wall of the channel 113 to process the internal thread. In addition, the mask member 110 of FIG. 8 and the bottom cover 210 of the projection device 1 are of a two-piece design. Therefore, in other embodiments, a thread groove may be directly set on the side wall of each hole 212 of the bottom cover 210 to process the same internal thread as the first threaded portion 115 of the mask member 110, so that when the second end 112b of the surrounding wall 112 is connected to the bottom cover 210 of the projection device 1, the internal thread provided on the inner wall of the channel 113 and the thread groove provided on the side wall of the opening 212 corresponding thereto jointly form continuous internal threads with the same specification.

In another embodiment, the first threaded portion 115 of the mask member 110 may be a nut 130 with the internal thread fixed/embedded on the inner wall of the channel 113. Specifically, each supporting module 100 may further comprise a nut 130, and the nut 130 is disposed in the mask member 110 and is located in the channel 113 adjacent to the opening 114 or in a position of the opening 114, so as to serve as the first threaded portion 115 of the mask member 110, and the entire inner wall of the channel 113 may be a smooth surface without internal threads (as shown in FIG. 5). When the rod 121 of the foot pad assembly 120 is screwed to the mask member 110 disposed in the projection device 1, the free end 121b of the rod 121 passes through the nut 130 disposed in the mask member 110, so that the second threaded portion 123 of the rod 121 and the nut 130 serving as the first threaded portion 115 of the mask member 110 are screwed to each other. In addition, the mask member 110 of FIG. 5 and the bottom cover 210 of the projection device 1 are of a two-piece design. Therefore, a nut 214 may be embedded in the side wall of each hole 212 of the bottom cover 210. The nut 214 has the same internal thread as the first threaded portion 115 of the mask member 110, so that when the second end 112 b of the surrounding wall 112 is connected to the bottom cover 210 of the projection device 1, the nut 130 serving as the first threaded portion 115 of the mask member 110 and the nut 214 embedded in the side wall of the hole 212 may both correspond to the second threaded portion 123 of the rod 121, and the first threaded portion 115 and the internal thread of the nut 214 corresponding to the hole 212 jointly form continuous internal threads with the same specification.

In one embodiment, the mask member 110 may be provided with a vent hole 50, the vent hole 50 communicates with the channel 113, a diameter of the vent hole 50 is smaller than the diameter of the channel 113 and also smaller than the diameter of the opening 114, and the diameter of the vent hole 50 is smaller than a diameter of the free end 121b of the rod 121. In this embodiment, specifically, the protection wall 111 of the mask member 110 is provided with the vent hole 50 (e.g., the protection wall 111 in FIG. 5 is provided with the vent hole 50), and the vent hole 50 communicates with the channel 113 and the interior of the projection device 1. The vent hole 50 communicates with the channel 113 and the interior of the projection device 1, so that when the rod 121 rotates relative to the mask member 110 and moves in the channel 113 in the opposite direction to the first direction (i.e., the negative Y-axis direction), the air in the channel 113 may be smoothly discharged from the vent hole 50, so as to prevent the rod 121 from compressing the air in the channel 113 to form resistance, causing the rod 121 and the foot pad 122 to be unstable or difficult to adjust, if the rod 121 moves in the opposite direction to the first direction due to the absence of the vent hole 50. In addition, by designing that the diameter of the vent hole 50 is smaller than the diameter of the channel 113 and also smaller than the diameter of the opening 114, even if the user removes the foot pad assembly 120 due to the need to use or install the projection device 1 to make the channel 113 where the foot pad assembly 120 is originally installed is exposed on the outer surface of the projection device 1, since the channel 113 is only provided with the vent hole 50, and the diameter of the vent hole 50 is smaller than the diameter of the channel 113 and also smaller than the diameter of the opening 114, it can effectively prevent the internal components of the projection device 1 from falling out through the vent hole 50 due to sparks or burning, or objects outside the projection device 1 from falling into the interior of the projection device 1 through the vent hole 50, thereby complying with safety regulations. For example, the diameter of the channel 113 and the diameter of the opening 114 may be 6 millimeters (mm), and the diameter of the vent hole 50 may be 2.5 mm. That is, the diameter of the vent hole 50 is smaller than half of the diameter of the channel 113, but it is not limited thereto. In other embodiments, the mask member 110 may be provided with vent holes on the surrounding wall 112, and the vent holes of the surrounding wall 112 communicate with the channel 113 and the interior of the projection device 1, so that when the rod 121 moves relative to the channel 113 of the mask member 110, the air in the channel 113 may be smoothly discharged from the vent holes.

In one embodiment, a maximum length of the rod 121 extending into the channel 113 may be less than a length L1 of the channel 113 in the first direction (i.e., the positive Y-axis direction) (as shown in FIG. 6). The maximum length of the rod 121 extending into the channel 113 may be, but is not limited to, the length L2 of the second threaded part 123 on the Y axis. (as shown in FIG. 7). In this embodiment, the rod 121 is configured to be unable to pass through the vent hole 50 provided on the protection wall 111 when the rod 121 is screwed to the channel 113 to the limit, so as to prevent the diameter of the vent hole 50 from being enlarged (as shown in FIG. 5).

In one embodiment, the surrounding wall 112 may have a tapered shape and may gradually expand outward from the protection wall 111 along the first direction (i.e., the positive Y-axis direction) (as shown in FIG. 6). By the tapered design of the surrounding wall 112, when the mask member 110 is manufactured by the injection molding manufacturing method, the releasability from the mold is good, thereby improving the production efficiency.

In one embodiment, the diameter of the channel 113 may gradually increase along the first direction (i.e., the positive Y-axis direction) from the protection wall 111 (as shown in FIG. 6). In other words, the channel 113 may be a tapered channel. When both the channel 113 and the surrounding wall 112 are tapered, the thickness of the surrounding wall 112 may be made uniform.

In one embodiment, the surrounding wall 112 may have an inclination angle θ relative to an axis parallel to the first direction (i.e., the positive Y-axis direction), and the inclination angle θ may be, but is not limited to, 7 degrees to 10 degrees (as shown in FIG. 6). The first direction is, for example, the moving direction of the rod 121 in the channel 113.

In one embodiment, the material of the mask member 110 and the bottom cover 210 of the projection device 1 may be the same (e.g., plastic).

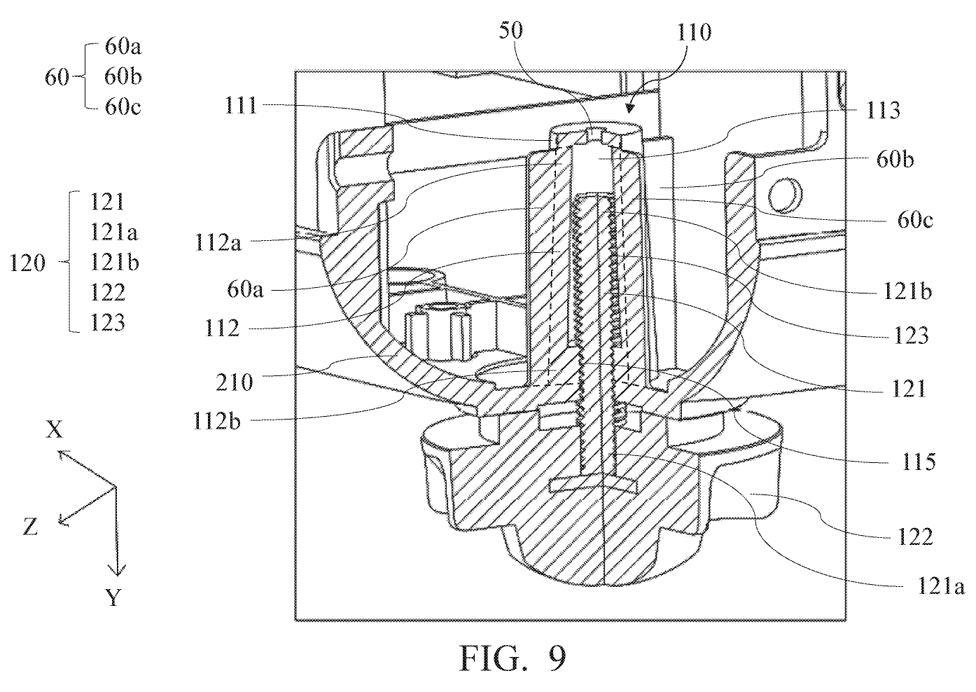

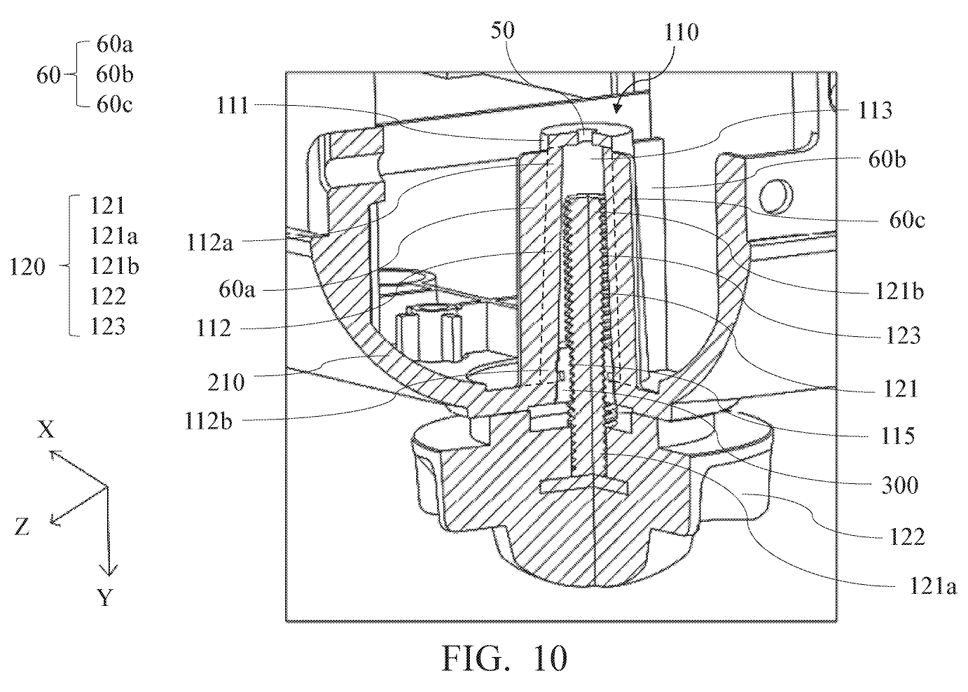

In the above embodiments of FIG. 1 to FIG. 8, the mask member 110 and the bottom cover 210 of the projection device 1 are of a two-piece design, but the present disclosure is not limited thereto. In other embodiments, the mask member 110 and the bottom cover 210 of the projection device 1 may be integrally formed (as shown in FIG. 9 and FIG. 10). FIG. 9 is a stereoscopic cross-sectional diagram of another embodiment of a supporting module of the present disclosure applied to a projection device, and FIG. 10 is a stereoscopic cross-sectional diagram of still another embodiment of a supporting module of the present disclosure applied to a projection device. In the embodiment, in order to reduce costs and reduce the assembly time by the reduction in assembly of the mask member 110 and the bottom cover 210 of the projection device 1, the mask member 110 and the bottom cover 210 of the projection device 1 may be integrally formed of plastic material. In one embodiment, after the mask member 110 and the bottom cover 210 of the projection device 1 are integrally formed, the thread grooves may be directly set on the inner wall of the channel 113 and the side wall of the opening 212 corresponding thereto, thereby processing continuous internal threads with the same specification (as shown in FIG. 9) for screwing to the second threaded portion 123 of the rod 121 of the foot pad assembly 120. In another embodiment, when the mask member 110 and the bottom cover 210 of the projection device 1 are designed to be integrally formed, a single nut 300 is embedded in the process of manufacturing the mask member 110 and the bottom cover 210 of the projection device 1 to form continuous internal threads with the same specification (as shown in FIG. 10) for screwing to the second threaded portion 123 of the rod 121 of the foot pad assembly 120.

In summary, the supporting module and the projection device of the embodiments of the present disclosure have at least one of the following advantages. The rod of the foot pad assembly selectively extends into the channel of the mask member through the opening of the mask member and the hole of the bottom cover of the projection device, and the second threaded portion of the rod of the foot pad assembly is selectively screwed to the first threaded portion of the mask member (i.e., the foot pad assembly is removable screwed to the mask member disposed in the projection device), so that the foot pad assembly can not only adjust the projection angle of the projection image projected by the projection device, but can also be selectively removed from the projection device in response to the diversified requirements of users for installing the projection device, thereby meeting actual applications. In addition, due to the design of the mask member with the vent hole, when the rod rotates relative to the mask member and moves in the channel in the opposite direction to the first direction, the air in the channel may be smoothly discharged from the vent hole. Besides, by the design of the vent hole with the diameter smaller than the diameter of the channel and the diameter of the opening, it can effectively prevent the internal components of the projection device from falling out through the vent hole due to sparks or burns, or the objects outside the projection device from falling into the interior of the projection device through the vent hole, thereby complying with safety regulations. Moreover, by the design of the rod extending into the channel with the maximum length smaller than the length of the channel in the first direction, the rod is prevented from entering the vent hole to enlarge the diameter of the vent hole. Furthermore, the mask member and the bottom cover of the projection device may be of a two-piece design, or an integrally formed design; when the mask member and the bottom cover of the projection device are integrally formed, the cost can be reduced, and the assembly of the mask member and the bottom cover of the projection device can be reduced, thereby reducing the assembly time.

The foregoing description of the preferred embodiments of the invention has been presented for purposes of illustration and description. It is not intended to be exhaustive or to limit the invention to the precise form or to exemplary embodiments disclosed. Accordingly, the foregoing description should be regarded as illustrative rather than restrictive. Obviously, many modifications and variations will be apparent to practitioners skilled in this art. The embodiments are chosen and described in order to best explain the principles of the invention and its best mode practical application, thereby to enable persons skilled in the art to understand the invention for various embodiments and with various modifications as are suited to the particular use or implementation contemplated. It is intended that the scope of the invention be defined by the claims appended hereto and their equivalents in which all terms are meant in their broadest reasonable sense unless otherwise indicated. Therefore, the term “the invention”, “the present invention” or the like does not necessarily limit the claim scope to a specific embodiment, and the reference to particularly preferred exemplary embodiments of the invention does not imply a limitation on the invention, and no such limitation is to be inferred. The invention is limited only by the spirit and scope of the appended claims. The use of “at least one of...and...” thereof herein may include “one or more of the items contained in the list”. For example, the use of “at least one of A and B” thereof herein may include only A, or only B, or A and B. Similarly, the use of “at least one of A, B, and C” thereof herein may include only A, or only B, or only C, or any combination of A, B, and C. Moreover, these claims may refer to use “first”, “second”, etc. following with noun or element. Such terms should be understood as a nomenclature and should not be construed as giving the limitation on the number of the elements modified by such nomenclature unless specific number has been given. The abstract of the disclosure is provided to comply with the rules requiring an abstract, which will allow a searcher to quickly ascertain the subject matter of the technical disclosure of any patent issued from this disclosure. It is submitted with the understanding that it will not be used to interpret or limit the scope or meaning of the claims. Any advantages and benefits described may not apply to all embodiments of the invention. It should be appreciated that variations may be made in the embodiments described by persons skilled in the art without departing from the scope of the present invention as defined by the following claims. Moreover, no element and component in the present disclosure is intended to be dedicated to the public regardless of whether the element or component is explicitly recited in the following claims.

What is claimed is:

1. A supporting module, which is applied to a projection device, comprising:
a mask member disposed in the projection device and comprising a protection wall and a surrounding wall, wherein the surrounding wall has a first end and a second end opposite to each other, the protection wall is located at the first end of the surrounding wall and connected to a periphery of the surrounding wall, the protection wall and the surrounding wall jointly define a channel, the channel extends along a first direction from the first end to the second end of the surrounding wall, the second end of the surrounding wall is connected to a bottom cover of the projection device and has an opening communicating with the channel, and the opening corresponds to a hole of the bottom cover, so that the channel communicates with outside of the projection device; the mask member has a first threaded portion; and
a foot pad assembly removably screwed to the projection device and comprising a rod and a foot pad, wherein the rod has a fixed end and a free end opposite to each other, the foot pad is fixed to the fixed end of the rod, the free end of the rod selectively extends into the channel through the opening and the hole, and the rod has a second threaded portion; when the rod is screwed to the projection device, the second threaded portion of the rod and the first threaded portion of the mask member are screwed to each other, and the foot pad is located outside the projection device.

2. The supporting module according to claim 1, wherein an outer surface of the rod comprises the second threaded portion and a non-threaded portion.

3. The supporting module according to claim 1, wherein the mask member is provided with a vent hole, the vent hole communicates with the channel, and a diameter of the vent hole is smaller than a diameter of the channel and also smaller than a diameter of the opening.

4. The supporting module according to claim 1, wherein a maximum length of the rod extending into the channel is less than a length of the channel in the first direction.

5. The supporting module according to claim 1, wherein the channel comprises the first threaded portion and an accommodation portion, the first threaded portion is an internal thread provided on an inner wall of the channel, and an inner wall of the channel corresponding to the accommodation portion is a smooth surface.

6. The supporting module according to claim 1, further comprising a nut, wherein the nut is disposed in the channel adjacent to the opening or in a position of the opening to serve as the first threaded portion of the mask member, and an inner wall of the channel is a smooth surface.

7. The supporting module according to claim 6, wherein when the rod is screwed to the projection device, the free end of the rod passes through the nut, so that the second threaded portion of the rod and the nut serving as the first threaded portion of the mask member are screwed to each other.

8. The supporting module according to claim 1, wherein the surrounding wall has a tapered shape, and the surrounding wall gradually expands outward from the protection wall along the first direction.

9. The supporting module according to claim 8, wherein the surrounding wall has an inclination angle relative to an axis parallel to the first direction, and the inclination angle is 7 degrees to 10 degrees.

10. The supporting module according to claim 1, wherein a diameter of the channel gradually increases from the protection wall along the first direction.

11. The supporting module according to claim 1, wherein when the rod is screwed to the projection device, the rod is configured to rotate relative to the mask member to move in the channel along the first direction or in an opposite direction to the first direction.

12. The supporting module according to claim 1, wherein the mask member is integrally formed with the bottom cover of the projection device.

13. A projection device, comprising:
a bottom cover provided with at least three holes;
at least three mask members disposed in the projection device and in one-to-one correspondence with the at least three holes, each one of the least three mask members comprising a protection wall and a surrounding wall; and
at least three foot pad assemblies in one-to-one correspondence with the at least three mask members, and removably screwed to the at least three mask members respectively, each one of the least three foot pad assemblies comprising a rod and a foot pad;
wherein, in each one of the least three mask members, the surrounding wall has a first end and a second end opposite to each other, the protection wall is located at the first end of the surrounding wall and connected to a periphery of the surrounding wall, the protection wall and the surrounding wall jointly define a channel, the channel extends along a first direction from the first end to the second end of the surrounding wall, the second end of the surrounding wall is connected to the bottom cover of the projection device and has an opening communicating with the channel, and the opening corresponds to one of the at least three holes of the bottom cover, so that the channel communicates with outside of the projection device; each one of the least three mask members has a first threaded portion; and
wherein, in each one of the least three foot pad assemblies, the rod has a fixed end and a free end opposite to each other, the foot pad is fixed to the fixed end of the rod, the free end of the rod selectively extends into the channel through the opening corresponding thereto and the hole corresponding thereto, the rod has a second threaded portion; when the rod is screwed to the projection device, the second threaded portion of the rod and the first threaded portion of the mask member corresponding thereto are screwed to each other, and the foot pad is located outside the projection device.

14. The projection device according to claim 13, wherein the channel of each one of the least three mask members comprises the first threaded portion and an accommodation portion, the first threaded portion is an internal thread provided on an inner wall of the channel, and an inner wall of the channel corresponding to the accommodation portion is a smooth surface.

15. The projection device according to claim 13, further comprising at least three nuts respectively disposed in the at least three mask members, wherein each one of the least three nuts is disposed in the channel adjacent to the opening or in a position of the opening to serve as the first threaded portion of the mask member, and an inner wall of the channel is a smooth surface.

16. The projection device according to claim 13, wherein each one of the least three mask members is provided with a vent hole communicating with the channel, and a diameter of the vent hole is smaller than a diameter of the channel and also smaller than a diameter of the opening corresponding thereto.

17. The projection device according to claim 13, wherein a maximum length of the rod of each one of the least three foot pad assemblies extending into the channel corresponding thereto is less than a length of the channel corresponding thereto in the first direction.

18. The projection device according to claim 13, wherein when the rod of each one of the least three foot pad assemblies is screwed to the projection device, the rod of each one of the least three foot pad assemblies is configured to rotate relative to the mask member corresponding thereto to move in the channel of the mask member corresponding thereto along the first direction or in an opposite direction to the first direction.

19. The projection device according to claim 13, wherein the surrounding wall of each one of the least three mask members has an inclination angle relative to an axis parallel to the first direction, and the inclination angle is 7 degrees to 10 degrees.

20. The projection device according to claim 13, wherein the at least three mask members are integrally formed with the bottom cover.
